(19) United States
(12) Patent Application Publication
(10) Pub. No.: US 2018/0063803 A1
(43) Pub. Date: Mar. 1, 2018

(54) System and method for production and synchronization of group experiences using mobile devices

(71) Applicants: Maik Andre Lindner, Marietta, GA (US); Wesley Satoru Mukai, Foster City, CA (US)

(72) Inventors: Maik Andre Lindner, Marietta, GA (US); Wesley Satoru Mukai, Foster City, CA (US)

(21) Appl. No.: 15/330,211

(22) Filed: Aug. 23, 2016

(51) Int. Cl. H04W 56/00; H04W 4/08

(52) U.S. Cl. CPC H04W 56/002; H04W 84/18; H04W 4/08

(57) ABSTRACT

A Utility for enabling an arbitrary number of mobile devices to be used to create a choreographed multimedia event exhibition while distributed over an arbitrary space. Each participating mobile device can present images, video, audio, and camera flash elements according to a pattern described by event attributes. As such each mobile device becomes a building block of the choregraphed multimedia event to form a specific exhibition. Event attributes can be distributed to participating mobile devices several ways including; messaging, local interfaces, position, location, motion, or programmatic defaults without the need for central orchestration or to communicate with one another or any external communication service during the exhibition. Participating mobile devices can join and leave an event exhibition at any time and will become synchronized with the event exhibition in progress. Example events are explained in detail and the usage of the event attributes is highlighted. The utility further enables the commercialization of individual choreographed multimedia event exhibitions. The commercialization is established by licensing terms dependent on the exhibition attributes such as placement, product and services placement, size of audience and rebroadcast capabilities.

### CROSS-REFERENCES TO RELATED APPLICATIONS

Not Applicable

### FEDERALLY SPONSORED RESEARCH

Not Applicable

### SEQUENCE LISTING OR PROGRAM LISTING

(if applicable)

### BACKGROUND OF THE INVENTION

### Field of Invention

This invention relates to the production and synchronized delivery of a multi-media experience using an arbitrary number of distributed mobile devices.

### Purpose

People carry mobile devices with them wherever they go for traditional communications, taking photos, and more often than not, social networking. Smart mobile devices are used for traditional communications and social media. Beyond this social network trend, there is a unique hardware-centric convergence occurring around mobile devices. Smart mobile devices not only have PC-experience processing power for communications and software applications, but also have studio quality cameras with LED flashes, high definition/brightness displays, accelerometers, navigation and positioning sensors, and high-fidelity audio input/output. This powerful, portable, and low cost “converged infrastructure” exists in an ever-expanding “supercharged” hardware technology environment, that includes omnipresent cellular, wi-fi, GPS positioning satellites, near-field communications and beacons.

However, people are not fully taking advantage of the hardware, social and mobile convergence that is in and around devices; they also do not have the right mindset. For example, at the April 2016 Facebook

Developer Conference, Facebook announced the outsourcing of the Facebook Surround 360 camera, which can capture 360-degree video at 60 frames per second. It is still a prototype and cost $30,000 to build; hence a state-of-the art innovation. At the event, Mark Zuckerberg, the CEO of Facebook, quoted to the San Francisco Chronicle, “We're always trying to get closer to this purest form of capturing an idea or an experience.” Zuckerberg is simply talking about capturing the experience, but what about using the hardware to be part of the experience. While smart mobile devices have the ability to interconnect people and further enable and extend their individual social expression, they tend to be used to do the exact opposite, namely reduce the interaction of people in any given situation and rather limit the real expression of feelings and shared, group experiences. Most interaction is happening on a virtual level without any relation to the exact location or the point in time, thus as asynchronous communication. People these days tend to participate in social events such as club dancing, movies, theatre, sport and music events, and games and form virtual groups and express feelings like joy and excitement through social media posts and online media sharing (picture uploads to social communities). Sharing and/or communication occurs mostly within existing known virtual groups or broadcast to larger, unknown communities. This invention will allow the formation of (ad hoc) groups of random people or friends and include their mobile devices into the group experience as an enabler. This experience will be forming a social bridge between the immediate physical situation and the virtual representation of it. A good example is the social success of flash mobs. The anonymous but yet group experience of a flash mob event and the crowd based communication have led to the great success of spontaneous events and gatherings. The invention will enable a new vehicle for social expression in a wide variety of events. The invention takes advantage of the multimedia ability and ubiquitous presence of mobile devices to produce a broad spectrum of group experiences customizable for any event or group gathering.

Commercialization of the invention builds from the fact that during an adhoc group experience, there is a unique participation and coordination of like-minded individuals bound by time, location, and intent. The adhoc experience and the collection/analysis or user data presents opportunities for spot communication, branding, and advertising. For example, a sports team might want to produce a group experience made up of the team colors changing back and forth in unison throughout the stadium. Fans would download the attributes of the experience to enable the invention to produce the experience anytime they join in. The invention includes logging information about experiences: what—where—when if downloads; what—where—when—duration of experiences. This information has unique market value and as such can be monetized and promoted through slight variants of traditional internet-based advertising business models.

Participation can be encouraged by giveaways, discounts, and loyalty points. The invention enables these and several other market place opportunities.

Viral recognition, deployment, and immediate participation are key to product uptake in today's digital market place. The very nature of the public experience produced by the invention creates a sense of “I want to take part in that” or “I want to do that too”. In essence, the invention advertises itself. Imagine the venture capital pitch surrounding this invention. One could place three mobile devices face up in a triangle on a table in front of the venture capitalist and start a synchronized displayed pattern that races around the triangle, based on the relative location of the three devices. In an adhoc fashion, the VC is asked to “join the group” via a simple registration and places his phone on the table, expanding the triangle to a square. Immediately the displayed pattern races around the newly formed square without “missing a beat”. The synchronized experience is controlled by time, venue, location, and movement in a unique way that allows participants to join in quickly at any time, even after the experience has started. Participants can also join discretely and participate in a group event without the longer lasting social pressure that comes from long term groups. Deployment of the attributes that produce an experience is simple and follows any number of available social media outlets such as Facebook, Google, Twitter, etc. The invention provides the ultimate in viral marketability and as such supports the business and participation objectives of the business behind the patent.

### BACKGROUND OF THE INVENTION

The one or more multi-media capable mobile devices people wear or carry with them at all times represents a unique resource for making a group experience or expression. Today if a group of people wanted to use their mobile devices to be part of an experience they would each individually have to setup their devices and position themselves to form an experience. A simple example would be a group of people at a concert venue. The hall is dark and the people want to express their connection with the performers so they might individually set their mobile devices to illuminate a solid white screen and then hold them up with the screen facing the performers and maybe rock their arm side to side in rhythm with the music. This illustrates a very basic group experience activity and this method of production and delivery. But what if they wanted all the devices to change colors at the same time, or blink to the rhythm of the music, or change colors based on the volume of the music, or even form a large image with each mobile device acting as a “pixel”. These ideas would be very difficult and would depend on the users constantly changing their display on their mobile device. The experience would require too much advance coordination and few if any participants could join in during the event. The advantage of this invention would make it possible to achieve synchronized experiences—like all participating devices changing to a predefined color based on such things as time, movement, sound, light, or, location.

Synchronizing a group of mobile devices to present the same thing at the same time is a basic necessity for the activity of presenting a group multi-media experience. Besides the manual approach described earlier, another possible option would be to live broadcast an image and audio wirelessly to all the mobile devices from a single source. In fact, the current state-of-the-art for experiences in concert settings include the streaming of the live audio and video to live audience member's phones so the individual can experience the music and visuals more intimately. The problem with this technique is that it doesn't scale well in terms of synchronization, in a venue with hundreds or even thousands of participating mobile devices. It also would incur data transmission costs that would tend to deter participation. Broadcasting to mobile devices is really meant for individual consumption whereby different arrival times to mobile devices is not seen. But if you could see all the mobile devices at the same time you would see these differing arrival times. Again, these factors would detract from participation in a group experience. The advantage of this invention is its ability to achieve synchronization without requiring a wireless transmission. Synchronization can be triggered or paced by a multitude of methods. The clock on the mobile device is one method. Audio or visual cues such as a loud sound, music beat, or firework flash (e.g. at the start of a sporting or concert event) can also be sensed through the microphone and camera of the mobile device. These methods can also be used to find and establish relative location. A second important advantage of this invention is that participants can join an experience at any time and immediately be synchronized with the ongoing experience. This is an important factor as it is desirable for the experience to have a flash-mob draw where more and more participants want to join as they see what is happening with the experience.

There are other examples of group experiences besides those of large venues like concerts. For example, consider small table top group experiences with multiple devices that could support games that require coordinating patterns or locations, like puzzles, dominos, concentration, or roulette. The experiences can scale from small gatherings to even larger ones like sporting events. Imagine during a night-time football game, where the display on each mobile device could change based on the stadium, the section, the row, or the seat of the participant. The advantage of this invention would be that participants would be able to join and leave the experience over and over again. So, when something happens such that the people in a section want to show appreciation they could just join an experience in progress and light up the section in a color or with synchronized flashes.

While either manual, wireless broadcast, or other device driven synchronization methods are possible neither supports an eye-ball based business model. In order to support a business model, this invention facilitates each participating mobile device to collect statistics on which experiences they participated in, for how long, and how often. This information would periodically be uploaded to the back-end business system where it could be used to issue bonus coupons for the participants in the venues they frequent and for operators to gather information necessary for ad-based business models. The key differentiator is that the grouping of like-minded participants for specific types of planned and adhoc events is a unique join of users, which offers unique value.

### SUMMARY OF THE EMBODIMENTS

A preferred embodiment consists of an Event which takes place in one or more distinct Locations. In each Location there are an arbitrary number of mobile devices taking part in an experience of one or more Scenes. Scenes are made up of a Sequence of Frames created by a Composite Generator using several media elements. A Generator's production of Composites can be static or dynamic over the duration of the Scene. Mobile devices participating in the experience can join or drop-out of participation at any time as many times as they wish. Statistics about participation are collected in order to support commercialization of this invention.

### BRIEF DESCRIPTION OF THE DRAWINGS—FIGURES

FIG. 1: System—Schematically illustrates the relationship of embodiments that interact to make a System that achieves the advantage of this invention

FIG. 2: Generator—Schematically illustrate further element detail of the Generator embodiment.

FIG. 3: Baseball Stadium—Illustration of an Experience Venue

FIG. 4: Mobile Device Screen Shots—Presents 6 illustrated screen shots (FIG. 4a-f) of mobile devices from login to Event participation

FIG. 5: Mobile Device Functional Block Diagram

FIG. 6: Network and Interactive Environment

FIG. 7: Campaign Manager Screen Shot—Illustration of business reporting backend software of the Campaign Manager

### BRIEF DESCRIPTION OF THE DRAWINGS—REFERENCE NUMBERS

| | | | |
|---|---|---|---|
| 101 | Event | 102 | Location |
| 103 | Scene | 104 | Generator |
| 105 | Composite | 106 | Sequence |
| 107 | Frame | 110 | Pattern |
| 111 | Audio | 112 | Flash |
| 113 | Mixer | 114 | Selection |
| 115 | Period | 121 | Existing-Event Button |
| 122 | Choose-Event Button | 123 | Event-Name |
| 124 | Countdown-Timer | 125 | Organizer |
| 126 | Participants | 127 | Join-Event |

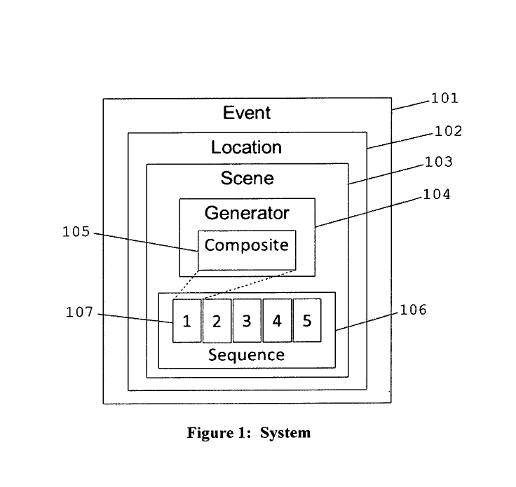

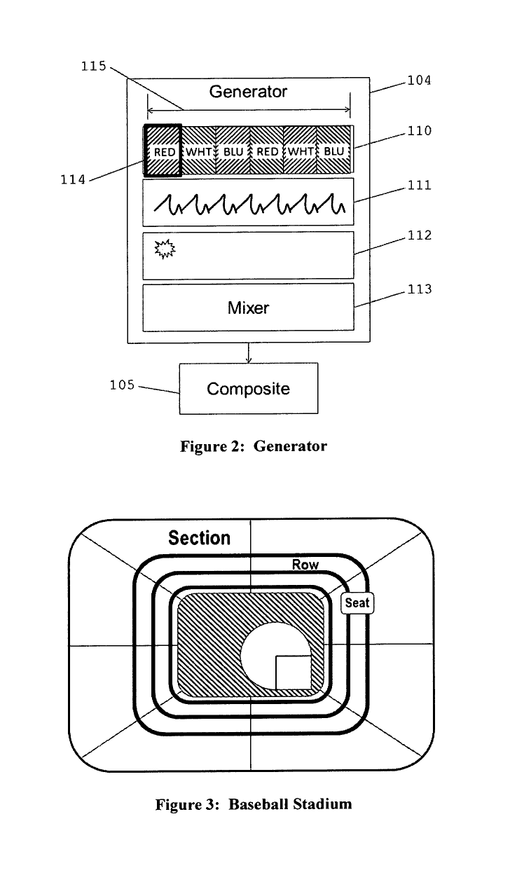

### DETAILED DESCRIPTION OF EMBODIMENTS—FIG. 1 and FIG. 2

FIG. 1 illustrates the embodiments that makeup this System and their relationship to each other. As this is fundamentally a Software System these embodiments will have variable names that appear in the software developed to prototype these embodiments. These names are provided throughout this document for consistency between this text and the software listings. An Event 101 is the main software embodiment that describes the experience activity of devices participating in a distributed multi-media experience. In our software prototype the Event 101 embodiment is named-object Event, and includes a key attribute which is the Event.Start-time. Examples of the Event 101 include hundreds of participating mobile devices displaying school colors during a sporting event, several people at a table playing a display game like concentration or puzzle, audio and video racing around a circle of mobile devices giving a spinning effect. A small group of people forming a moving banner that says “Happy Birthday” while playing a person singing the Happy Birthday song on all the mobile devices to sound like a crowd. Multi-angle video being presented on mobile devices in a small circle facing inward, as people in the middle of the circle look different directions they see what the image looks like from different angles. This type of Event 101 could also be reversed where the mobile devices in the circle face outward. Then people moving around the outside of the circle would see the image from different angles. Because the preferred embodiment is with mobile devices the Event 101 can literally be mobile where all participants are moving down a road or walking around in a city yet still able to participate in a form of distributed experience that likely will vary based on where the participant is, which way, or how fast they are moving.

The Event 101 contains one or more Location 102 software embodiments that distinguishes devices participating within the Event 101 at different locations. In our software prototype the Location 102 embodiment is named-object Event.Location. Examples of the Location 102 include GPS coordinates, in the presence of a beacon signal, or a participant manually scanning or entering location information like the section number, row number, and seat number from the Baseball Stadium, FIG. 3. The Location 102 information can be used to vary the production thereby producing different experiences. For example, using the section information from the Baseball Stadium FIG. 3 the experience could have every participating mobile device in the same section displaying the team colors in sequence together. Using row information from the Baseball Stadium FIG. 3 the experience could flash all the mobile devices in the first row then the second row etc. in rings all around the stadium. Finally, using seat information from the Baseball Stadium FIG. 3 the participating mobile devices on one side of the stadium could form a large image of the team logo with each mobile device acting as a pixel in the logo.

The Location 102 contains one or more Scene 103 software embodiments that further distinguish a specific Scene 103 that a device is participating in at the Location 102 within the Event 101. In our software prototype the Scene 103 embodiment is named-object Event.Location.Scene. Examples of the Scene 103 include experiences produced based on the Event 101 and the Location 102. Several Scene 103 can be available for production at the same time such that they can be produced sequentially or looped or varied based on other attributes.

The Scene 103 contains one or more Generator 104 software embodiments that produce a Sequence 106 of Frames 107 that make up the Scene 103 for a mobile device participating in an experience at the Location 102 within the Event 101. In our software prototype the Generator 104 embodiment is named-object Event.Location.Scene.Generator. Examples of the Generator 104 include color blocks, fixed or moving images, and media and control elements. For an experience Event 101 at a ballgame in a Baseball Stadium FIG. 3, in a given section Location 102, of the team colors Scene 103, the Generator 104 would contain information such as the team colors, the order and duration of each color, the brightness and on-off blinking controls.

The Generator 104 contains several experience media elements used to produce a Composite 105 that will be used as the next multi-media Frame 107 in the Sequence 106 that is the production of the Scene 103 for the mobile device participating in a group experience at the Location 102 within the Event 101. In our software prototype the Composite 105 embodiment is named-object Event.Location.Scene.Generator.Composite. The Composite 105 is the production of the final mix of all the media elements and controls necessary to form a single Frame 107 in the Scene 103 Sequence 106.

FIG. 2 is an expanded view of the Generator 104 embodiment introduced in FIG. 1. The Generator 104 contains media elements and software necessary to build the Composite 105 that is used to produce one or more Frames 107 of the Sequence 106 making up the Scene 103. The Image 110 media element contains some or all of the graphic for one or more Composites 105. A mask is placed over the Pattern 110 in order to extract a Selection 114 of the Pattern 110 for the current Composite 105. The placement of the mask is determined by the sequencing algorithm which can consider the Event 101, Location 102, Scene 103, and Frame 107 attributes. In FIG. 2 the Selection 114 is shown as the first of 6 possible color blocks that make up the display Period 115 of the Generator 104. In this case the placement of the mask is determined simply by a function of the Frame 107 number using Equation 1.

### Equation 1: Frame Number & Pattern Selection Calculation

Event.Location.Scene.CurrentTime−Event.Location.Scene.Start_Time=Event.Location.Scene.Run_Time+Event.Location.Scene.Frame_Time=Event.Location.Scene.Current Frame MOD Event.Location.Scene.Generator.Pattern.Period=Event.Location.Scene.Generator.Pattern.Selection

In this case the Selection 114 of the Pattern 110 is a solid Red color block. Since, the Frame 107 number Event.Location.Scene.Current_Frame can be determined at any time using Equation 1 it is possible for a mobile device to join in to an Event 101 at any time and be in sync with the other mobile devices already active in the Event 101. Likewise, the mask placement on the Pattern 110 to determine the Selection 114 can be determined with Equation 1 using the Generator 104 Period 115 for any given Frame 107. The Selection 114 can be changing from Frame 107 to Frame 107 or remain static throughout the Scene 103. Likewise, the Pattern 110 itself can static or be changing over time as with a video stream throughout the Scene 103.

The Audio 111 media element contains audio that may or may not be synchronized with the Pattern 110 media element. It could be real time from a wireless broadcast source or from content local to the participating mobile device that may have been downloaded from a networked source.

The Flash 112 media element contains flash commands that instruct how the flash will be fired, single or multiple, intensity, frequency etc. The Flash 112 may be instructed to synchronize with other media elements or the Frame 107 count.

The Mixer 113 media element contains controls that govern the Composite 105 production. This would include controls such as the volume of the audio, the brightness of the display, the mix of elements over time, the duration of each Frame 107, and adjustments made in response to movement or shaking of the mobile device. The Mixer 113 extends the Composite 105 production possibilities to be virtually limitless.

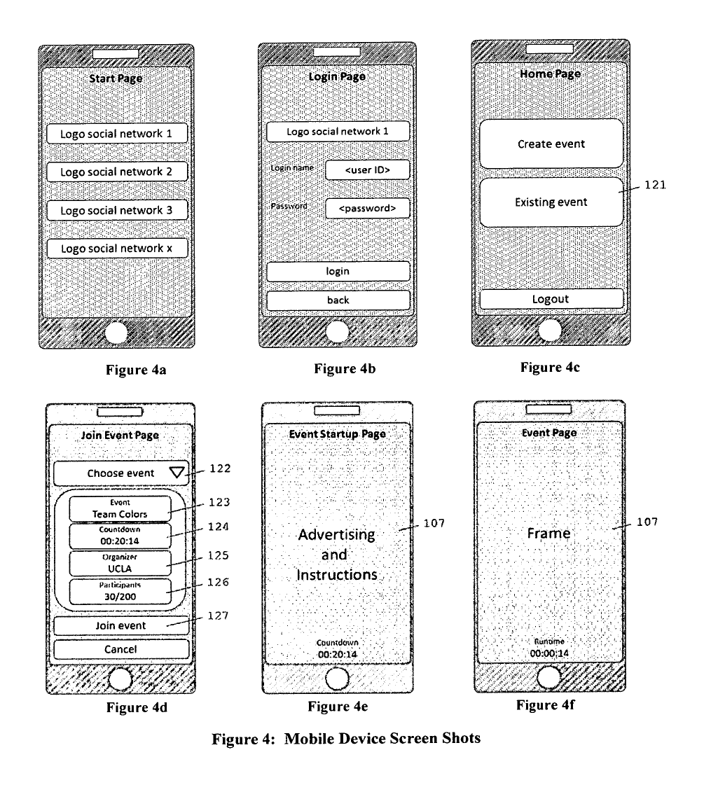

### METHOD OF OPERATION—FIG. 4

From the users' perspective, the basic method of operation of this invention can be seen in the series of mobile device screen shots found in FIG. 4. These screen shots represent displays from the prototype mobile device application of the invention.

The series begins with the application's Start-Page FIG. 4a where the user is prompted to select a social network with witch to login and establish an identity. Assume they select Social Network 1 which bring them to the Login-Page FIG. 4b of that network. Here they provide their Login-Name & Password in typical fashion. After a successful login the user is presented with the invention application's Home-Page FIG. 4c. Here the user can choose to join an existing Event 101 or create a new Event 101. Assume they choose to join an existing Event 101 by clicking on the Existing-Event Button 121.

They are now on the Join-Event Page FIG. 4d where they will be able to see the list of downloaded Events 101. They can click the Choose-Event button 122 to see a drop-down list of available Events 101. Assume they select the “Team Colors” Event 101 from this drop-down list causing four details of the Event 101 to be shown in the center of the screen. These include the Event-Name 123, Countdown-Timer 124, Organizer 125, and Participants 126. The Countdown-Timer 124 shows that this Event 101 is scheduled to start in 20 minutes and 14 seconds. Assume this is the Event 101 the user is wanting to join so they click on the Join-Event Button 127 on this screen. The user is now presented the Event-Startup Page FIG. 4e. On this page advertising can be presented while the user is waiting for the Event 101 to start. Additional information can also be requested from the user on this page e.g., Location 102, Scene 103, Pattern 110, or Audio 111.

If the user closes their mobile device while on this screen the application will notify the user when the Event 101 is within seconds of starting so they can open their mobile device and position the device for experience. When the Event 101 starts the mobile device switches automatically to the Event-Page FIG. 4f displaying the current Frame 107. The user is now participating in the group experience and their mobile device is synchronized in time, venue, location, and motion with other mobile devices participating in this Event 101. The user is able to close their mobile device at any time and then reopen it and the application will resync the device to all the other devices currently in the experience.

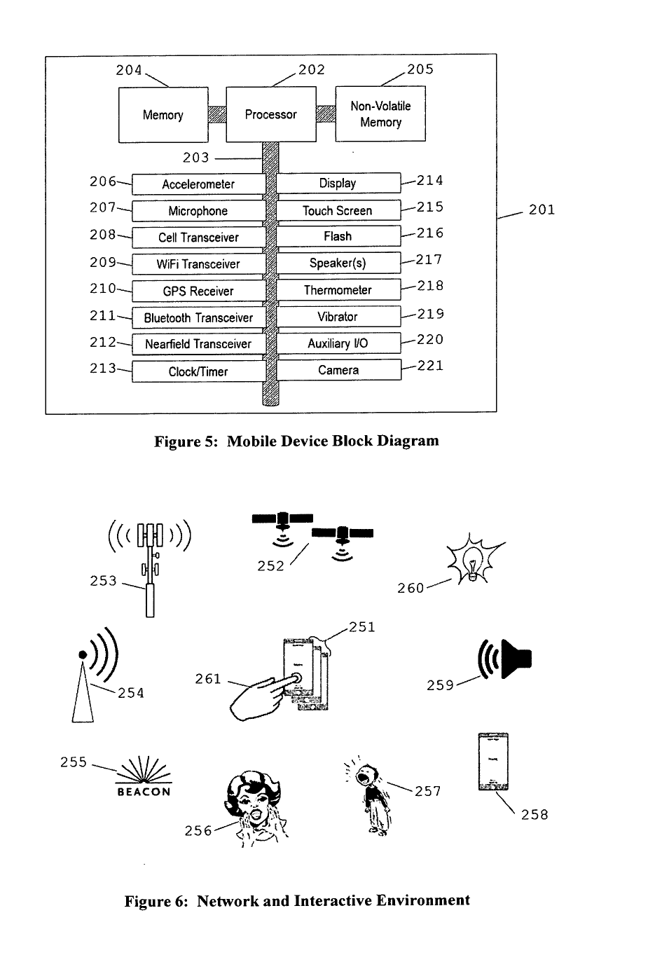

### FUNCTIONAL BLOCK DIAGRAM OF MOBILE DEVICE—FIG. 5

FIG. 5 describes a typical Mobile Device 201 containing a central Processor 202 that is connected to a number of other functional elements via an internal communications Bus 203. Some Memory 204 as well as some Non-Volatile Memory 205 is resident on the Bus 203 holding the necessary software and Event 101 attributes. Several other functional elements are connected to the Processor 202 by the Bus 203 that can help establish interaction with the group experience in real-time. These include but are not limited to the Accelerometer 206, Microphone 207, Cell Transceiver 208, WiFi Transceiver 209, GPS Receiver 210, Bluetooth Transceiver 211, Nearfield Transceiver 212, Clock/Timer 213. Additional elements include the Display 214, Touch Screen 215, Flash 216, Speaker(s) 217, Thermometer 218, Vibrator 219, Auxiliary I/O 220, and Camera 221. The combination of these elements to interact with the environment before or during a group experience is virtually limitless. Mostly, they help establish or modify the Event 101 attributes based on detecting information that can be interpreted for attribute values.

### NETWORK AND INTERACTIVE ENVIRONMENT—FIG. 6

The group of Mobile Devices 251 participating in an experience are operating within a complex network of information and stimulation sources. FIG. 6 illustrates a range of examples available at the time of this application but they will continue to grow over time to include more biometric and electronic signaling from the Internet of Things. Show here are GPS Satellites 252, Cell Tower Transceivers 253, WiFi Transceivers 254, Proximity Beacons 255, Voice Recognition 256, Noise Levels 257, Information from other Mobile Devices 258, Audio Speakers 259, Photographic Flash 260, and Touch Screen Input 261. This complex network of stimulation sources can be used to gather timing and other Event 101 attributes.

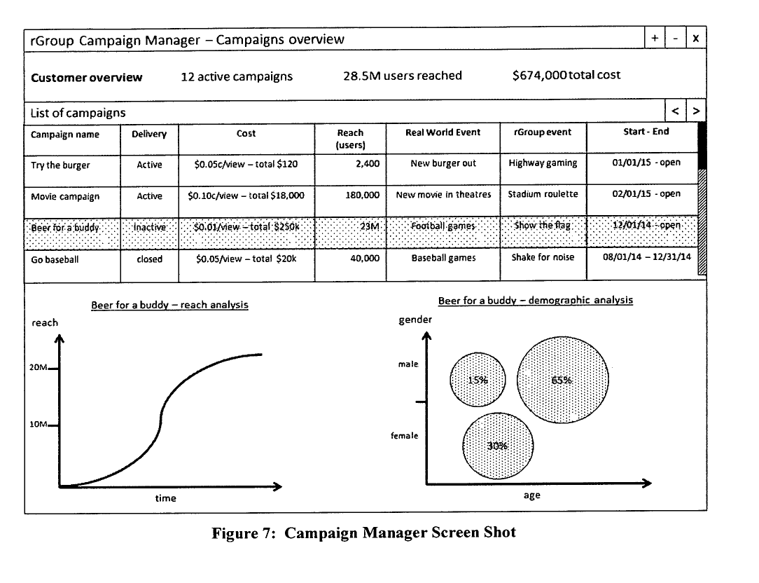

### COMMERCIALIZATION—FIG. 7

The invention opens the door for several commercialization opportunities while at the same time enabling a simple viral participation in planned or adhoc group experiences. In a very real sense, the public nature of the invention's group experience self-advertises and people watching start wanting to be a part of the experience or to take pictures of the experience. The experience can also be unbounded by time and space such that anyone anytime anywhere could join an open-ended event. An example would be a simple color changing pattern of pink and white as a symbol of support for the cure for Breast Cancer. In this example, the participation could be sponsored such that donations could be made based on the duration of the experience or number of active participants anytime or anyplace. People could participate in real-time during a live television broadcast and the participant and donation values shown in real time though people would be participating in their homes or other venues. This would be just one of the creative ways to make use of the event participation logs. The screen shot in FIG. 7 illustrates the reporting made possible by the event participation logs. Commercialization of the invention builds from the fact that during an adhoc group experience, there is a unique participation and coordination of like-minded individuals bound by time, location, and intent. The adhoc experience and the collection/analysis or user data presents opportunities for spot communication, branding, and advertising.

Professional Event Production

An Event production can be professionally produced with high degrees of artistry and value-added content. Even though the invention provides basic mobile device multimedia experience capabilities the ability to create artistry and brand recognition is unlimited. As part of commercialization production development software can be licensed or franchised. The Software right to use either as a service or by inclusion can be commercialized.

Branded Event Promotion

Use of the invention can be promoted for professional or non-professional activities such as sporting, musical, educational, personal development, or entertainment venues. When the invention enables a promotional event branding of the invention can be required as part of the commercialization of the invention.

Metered Event Participation

Metering of participation in an experience can lead to marketing value and use fees. Although, the invention is intended to support viral participation, the invention software in each Mobile device can shut down an experience that may be endangering public safety.

Event Experience Re-Broadcast Rights

The experience resulting from the invention is free for public consumption. However, the broadcast, rebroadcast, or recording of an experience for commercial purposes can and should be limited to at least support accreditation during the broadcast or rebroadcast of an experience originally made using the invention.

1. A utility for enabling a group of mobile devices to participate in a choreographed multimedia event exhibition for an audience.

2. The utility of claim 1 wherein said group is an arbitrary number of mobile devices.

3. The utility of claim 1 wherein said group membership is dynamic, determined by request, invitation, or registration.

4. The utility of claim 1 wherein said audience may or may not include members of the group involved in the event exhibition.

5. The synchronization of event attributes by a group of mobile devices participating in an event exhibition.

6. The event exhibition of claim 5 wherein said synchronization is based on time elements.

7. The event exhibition of claim 5 wherein the said synchronization is based on location elements.

8. The event exhibition of claim 5 wherein the said synchronization is based on motion elements.

9. The event exhibition of claim 5 wherein the said synchronization is based on audio elements.

10. The event exhibition of claim 5 wherein the said synchronization is based on signaling elements.

11. The event exhibition of claim 5 wherein the said synchronization is based on video elements.

12. The commercialization of choreographed distributed multimedia event exhibition of mobile devices.

13. The commercialization of event exhibition of claim 12 wherein the said commercialization is based on the location of the event exhibition.

14. The commercialization of event exhibition of claim 12 wherein said commercialization is based on including advertisement for commercial products and services in the event exhibition.

15. The commercialization of event exhibition of claim 12 wherein said commercialization is based on the event having multiple occurrences of the event exhibition.

16. The commercialization of event exhibition of claim 12 wherein said commercialization is based on the number of participants and the length of time they participate in the event exhibition.

17. The commercialization of event exhibition of claim 12 wherein said commercialization is based on the size of the audience viewing the event exhibition.

18. The commercialization of event exhibition of claim 12 wherein said commercialization is based on the live or recorded rebroadcast of the event exhibition.
